(19) United States
(12) Patent Application Publication
(10) Pub. No.: US 2023/0415062 A1
(43) Pub. Date: Dec. 28, 2023

(54) PORTABLE MTB RAMP 'AIR'

(71) Applicant: UAB Gravitacija mes tikim, Vilnius (LT)

(72) Inventor: Linas Gliaudelis, Vilnius (LT)

(21) Appl. No.: 18/212,678

(22) Filed: Jun. 21, 2023

Related U.S. Application Data
(60) Provisional application No. 63/328,799, filed on Jun. 23, 2022.

(51) Int. Cl. A63K 3/00

(52) U.S. Cl. CPC A63K 3/00

(57) ABSTRACT

Disclosed herein is a portable mountain bike ramp (MTB ramp) assembly comprising a plurality of components including a foldable frame having a plurality of frame sides and a ramp surface on top. The ramp surface is capable of being folded along with the foldable frame to facilitate portability when not in use. A pair of adjustable height legs is provided that is connected to one of the plurality of frame sides using a leg lock. A pair of wheel extensions are adapted in between the pair of adjustable height legs. A rubber foot assembly is provided below each of the pair of adjustable height legs to provide a firm grip on the ground when the MTB ramp assembly is in use.

### CROSS REFERENCE TO RELATED APPLICATIONS

The present application claims the benefit of U.S. Provisional Patent Application No. 63/328,799 filed on Jun. 23, 2022, the contents of which are incorporated herein by reference in their entirety.

### FIELD OF THE DISCLOSURE

The present invention relates to ramps for mountain bikes (MTB), and is particularly, applicable to portable ramp assemblies for mountain bikes.

### BACKGROUND OF THE DISCLOSURE

Mountain bikes (MTB) generally require air ramps are generally designed for providing high jumps.

A problem associated with existing MTB air ramps is that they are not strong enough for long-term usage. The existing ramps are not adjustable according to the requirement of the bikers or the users. Many existing ramps designed for mountain bikes are not portable, not easily transportable, and cost-effective. Prior available sports ramps are not holistic as they do not involve mechanisms that are easy to assemble or install. In addition, the prior art ramps do not facilitate smooth landing, and the users or the riders find it difficult to jump.

It is therefore desirable to provide a portable MTB air ramp which has improved mechanisms designed for height-oriented jumps for advanced riders.

### SUMMARY

The present invention provides a portable mountain bike ramp (MTB ramp) assembly is provided. The portable mountain bike ramp (MTB ramp) assembly comprises a plurality of components including: a foldable frame having a plurality of frame sides and a ramp surface on top, the ramp surface capable of being folded along with the foldable frame; to facilitate portability when not in use; a pair of adjustable height legs, each of the pair of adjustable height legs connected to one of the plurality of frame sides using a leg lock; a pair of wheel extensions adapted in between the pair of adjustable height legs; and a rubber foot assembly provided below each of the pair of adjustable height legs to provide a firm grip on the ground when the MTB ramp assembly is in use.

According to an embodiment of the present subject matter, the ramp surface provides an inclined surface for facilitating dirt jumping for a mountain biker.

According to an embodiment of the present subject matter, the pair of adjustable height legs provide vertical support to the ramp surface.

According to an embodiment of the present subject matter, the ramp surface provides a progressive jumping geometry and is oriented for height jumps.

According to an embodiment of the present subject matter, the top ramp surface comprises a plurality of foldable parts made up of non-slip material including wood.

According to an embodiment of the present subject matter, the plurality of components is bonded together using a bungee cord.

According to an embodiment of the present subject matter, the rubber foot assembly includes a circular wooden plate surrounded by a rubber ring.

According to an embodiment of the present subject matter, the circular wooden plate is provided with a slit to receive and thereby secure a corresponding adjustable height leg.

According to an embodiment of the present subject matter, the pair of wheel extensions allows moving the portable mountain bike ramp (MTB ramp) assembly in a ready-to-use form from one location to another location without disassembling the same.

According to an embodiment of the present subject matter, the portable mountain bike ramp (MTB ramp) assembly is capable of being disassembled to allow portability by stacking up the plurality of components together wherein the pair of wheel extensions are mounted on one of the frame sides.

Other objects and advantages of the embodiments herein will become readily apparent from the following detailed description taken in conjunction with the accompanying drawings.

### BRIEF DESCRIPTION OF THE DRAWING

Preferred embodiments of the invention will now be described by way of non-limiting examples only by reference to the accompanying drawings, in which:

FIG. 1, according to an embodiment of the present invention, is an exploded view of the portable AIR ramp assembly.

FIG. 2, according to an embodiment of the present invention, is a perspective view of the ramp assembly.

FIG. 3, according to an embodiment of the present invention, shows construction of the portable AIR ramp with a special leg lock and rubber foot that provides usability and structural integrity features.

FIG. 4, according to an embodiment of the present invention, shows the portable AIR ramp when disassembled and packed.

Like reference numerals refer to like parts throughout the description of several views of the drawings.

### FIGURES REFERENCE NUMERAL

| | |
|---|---|
| 10 | portable mountain bike ramp (MTB ramp) assembly |
| 20 | a foldable frame |
| 30 | plurality of frame sides |
| 40 | ramp surface |
| 50 | adjustable height legs |
| 60 | leg lock |
| 70 | a pair of wheel extensions |
| 80 | rubber foot assembly |
| 90 | bungee cord |
| 100 | circular wooden plate |
| 110 | rubber ring |
| 120 | Slit provided on the circular wooded plate |
| 130 | wheel extensions are mounted on one of the plurality of frame |
| | sides |
| 140 | wheel |

### DESCRIPTION OF PREFERRED EMBODIMENT

This section is intended to provide an explanation and description of various possible embodiments of the present invention. The embodiments used herein, and various features and advantageous details thereof are explained more fully with reference to non-limiting embodiments illustrated in the accompanying drawings and detailed in the following description. The examples used herein are intended only to facilitate an understanding of ways in which the embodiments herein may be practised and to further enable the person skilled in the art to practice the embodiments used herein. Also, the examples/embodiments described herein should not be construed as limiting the scope of the embodiments herein. Corresponding reference numerals indicate corresponding parts throughout the drawings.

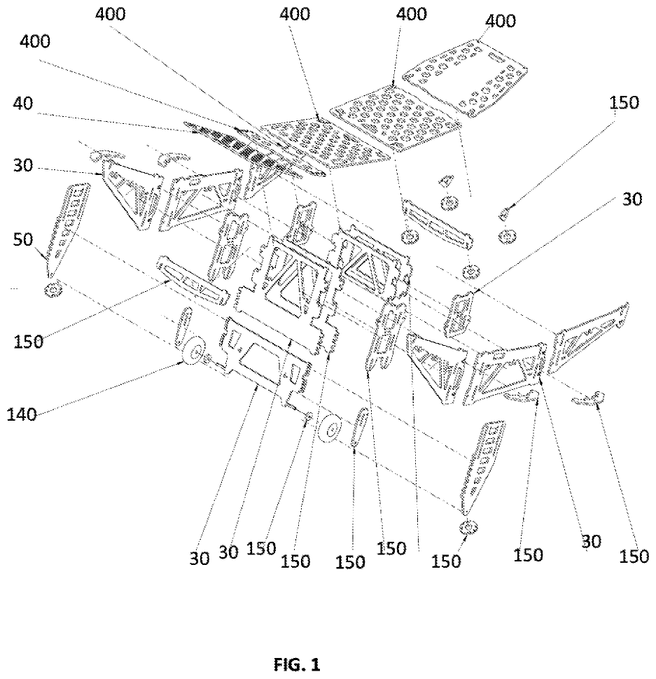

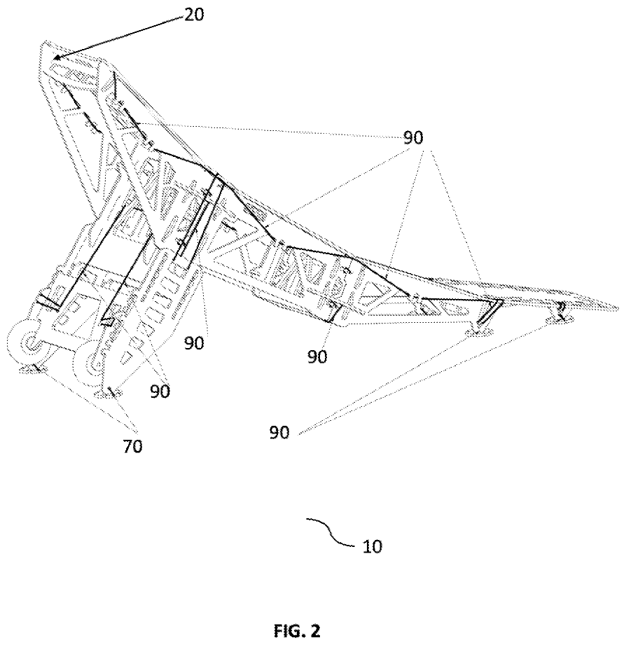

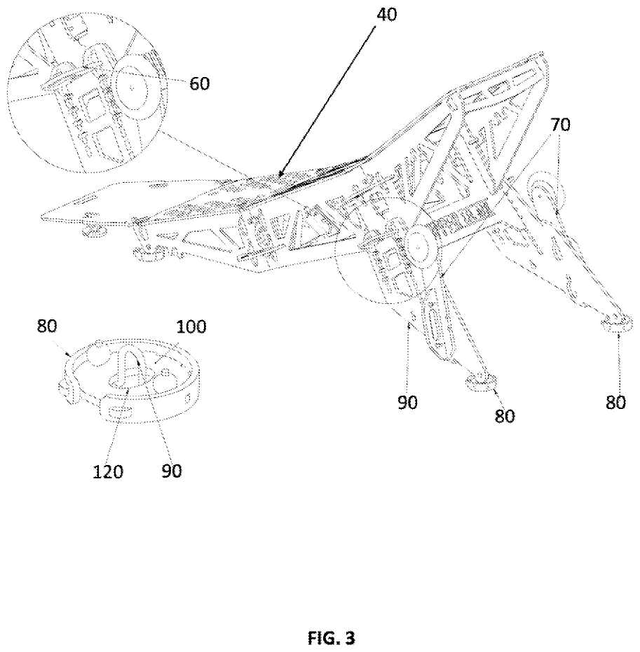

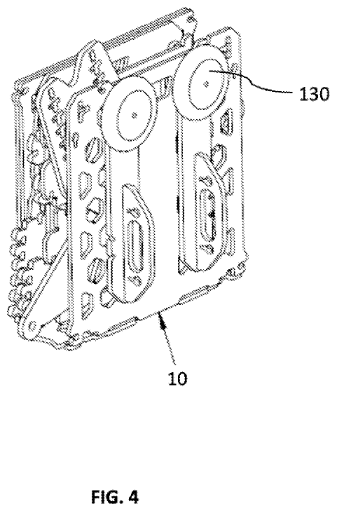

FIG. 1, according to an embodiment of the present invention, is an exploded view of the portable AIR ramp assembly. FIG. 2, according to an embodiment of the present invention, is a perspective view of the ramp assembly. FIG. 3, according to an embodiment of the present invention, shows the construction of the portable AIR ramp with a special leg lock and rubber foot that provides usability and structural integrity features. FIG. 4, according to an embodiment of the present invention, shows the portable AIR ramp when disassembled and packed.

Referring now to FIG. 1 through FIG. 4, the portable mountain bike ramp (MTB ramp) assembly comprises a plurality of components 150 including a foldable frame 20 having a plurality of frame sides 30 and a ramp surface 40 on top. The ramp surface 40 provides an inclined top surface for facilitating dirt jumping for a mountain biker. The ramp surface 40 has a progressive jumping geometry and is oriented for height jumps. The ramp surface 40 is a rolling (or riding) surface suitable for dirt jumping.

The ramp surface 40 is capable of being folded along with the foldable frame 20. This facilitates easy portability when the ramp assembly 10 is not in use. Further, a pair of adjustable height legs 50 are provided wherein each adjustable height leg is connected to one of the frame sides 30 using a leg lock. The pair of adjustable height legs 50 provide vertical support to the ramp surface 40. The adjustable height legs 50 used with the special leg lock 60 provide extra safety from vibration emerging from the jumping by the rider.

A pair of wheel extensions 70 is adapted in between the pair of adjustable height legs 50 and a rubber foot assembly 80 is provided below each of the pair of adjustable height legs 50 to provide a firm grip on the ground when the MTB ramp assembly 10 is in use. The rubber foot assembly 80 includes a circular wooden plate 100 surrounded by a rubber ring 110. The circular wooden plate 100 is provided with a slit 120 to receive and thereby secure a corresponding adjustable height leg 50. The rubber foot assembly 80 design comprises the special CNC-milled rubber belt assembled on the circular wooden plate 100 and elastic rope 90. Such design ensures excellent grip with any surface, therefore hard (e.g., concrete) or soft (e.g., grass) goes well with this kind of foot design. Additionally, rubber provides micro cushioning that goes well with the overall user experience.

Further, the top ramp surface 40 comprises a plurality of foldable parts 400 made up of non-slip material including wood.

According to an embodiment of the present subject matter, the plurality of components is bonded together using a bungee cord 90. The portable mountain bike ramp (MTB ramp) assembly 10 is capable of being disassembled to allow portability by stacking up the plurality of components together, wherein the pair of wheel extensions 70 are mounted on one of the frame sides 30. Also, the pair of wheel extensions allows moving the portable mountain bike ramp (MTB ramp) assembly in a ready-to-use form from one location to another location without disassembling the same. The rest of the components 150 have been shown in the exploded view of the ramp assembly in FIG. 1.

According to the embodiments of the present subject matter, the portable MTB ramp assembly 10 also called as an ‘AIR ramp’, is intended for MTB riders' sole training and events. This portable MTB ramp assembly 10 is CNC machined from painted high-quality birch plywood. As described above, the primary constructional parts of the ramp assembly 10 are bonded together with the bungee cord 90 (i.e. elastic rope) using no screws or any other fixing devices. The bungee cord may be released to disassemble the various parts of the ramp assembly 10. The MTB ramp assembly 10 is easily portable and can also be easily assembled. The portable MTB ramp assembly 10 can be placed in various locations that do not have any infrastructure or any surface preparation for this kind of sports or leisure activities that comprise MTB riding and jumping. As regard to performance, the portable MTB ramp assembly 10 or the ‘AIR ramp’ stands out in the state of the art as having progressive jumping geometry, meaning that it is oriented for height jumps. The portable MTB ramp assembly 10 is meant to be used by advanced riders. The surface of the ramp is not suitable for small wheel sports. It can be used with dirt/slopestyle hikes, enduro, downhill, BMX, skis, snowboards, etcetera. Further, the AIR ramp is very stable and adaptive to any surface/terrain. It can be placed at various angles by regulating the length of each leg. Also, it is possible to change the radius of the surface as per the requirements.

The usability and quick assembly are one of the fundamental features of AIR ramp, the leg with adjustable height construction enables users to change height and the overall setup on the go.

FIG. 4 shows the drawing of a disassembled ramp 10 to a suitcase. The portable ramp assembly is designed in such a manner to enables the user to pack the ramp in form of a portable set that is suitable to place in a relatively small space. Such suitcase assembly enables users to keep it under the bed, in a shelf, or transport it in a small car trunk.

The term exemplary is used herein to mean serving as an example. Any embodiment or implementation described as exemplary is not necessarily to be construed as preferred or advantageous over other embodiments or implementations. Further, the use of terms such as including, comprising, having, containing and variations thereof, is meant to encompass the items/components/process listed thereafter and equivalents thereof as well as additional items/components/process.

Although the subject matter is described in language specific to structural features and/or acts, it is to be understood that the subject matter defined in the claims is not necessarily limited to the specific features or process as described above. In fact, the specific features and acts described above are disclosed as mere examples of implementing the claims and other equivalent features and processes which are intended to be within the scope of the claims.

1. A portable mountain bike ramp (MTB ramp) assembly comprising:
a plurality of components including:
a foldable frame having a plurality of frame sides and a ramp surface on top, the ramp surface capable of being folded along with the foldable frame; to facilitate portability when not in use;
a pair of adjustable height legs, each of the pair of adjustable height legs connected to one of the plurality of frame sides using a leg lock;
a pair of wheel extensions adapted in between the pair of adjustable height legs; and
a rubber foot assembly provided below each of the pair of adjustable height legs to provide a firm grip on the ground when the MTB ramp assembly is in use.

2. The portable mountain bike ramp (MTB ramp) assembly of claim 1, wherein the ramp surface provides an inclined surface for facilitating dirt jumping for a mountain biker.

3. The portable mountain bike ramp (MTB ramp) assembly of claim 1, wherein the pair of adjustable height legs provide vertical support to the ramp surface.

4. The portable mountain bike ramp (MTB ramp) assembly of claim 1, wherein the ramp surface provides a progressive, jumping geometry and is oriented for height jumps.

5. The portable mountain bike ramp (MTB ramp) assembly of claim 1, wherein the top ramp surface comprises a plurality of foldable parts made up of non-slip material including wood.

6. The portable mountain bike ramp (NUB ramp) assembly of claim 1, wherein the plurality of components is bonded together using a bungee cord.

7. The portable mountain bike ramp (MTB ramp) assembly of claim 1, wherein the rubber foot assembly includes a circular wooden plate surrounded by a rubber ring.

8. The portable mountain hike ramp (MTB ramp) assembly of claim 7, wherein the circular wooden plate is provided with a slit to receive and thereby secure a corresponding adjustable height leg.

9. The portable mountain bike ramp (MTB ramp) assembly of claim 1, wherein the pair of wheel extensions allows to move the portable mountain hike ramp (MTB ramp) assembly in a ready-to-use form from one location to another location without disassembling the same.

10. The portable mountain bike ramp (MTB ramp) assembly of claim 1, capable of being disassembled to allow portability by stacking up the plurality of components together wherein the pair of wheel extensions are mounted on one of the plurality of frame sides.
